(19) United States
(12) Patent Application Publication
(10) Pub. No.: US 2023/0377144 A1
(43) Pub. Date: Nov. 23, 2023

(54) DETECTING SCAN AREA WITHIN HEMATOLOGY SLIDES IN DIGITAL MICROSCOPY

(71) Applicant: SCOPIO LABS LTD., Tel Aviv (IL)

(72) Inventors: Ittai MADAR, Tel Aviv (IL); Shahar KARNY, Hod HaSharon (IL); Eran SMALL, Yahud (IL); Erez NA'AMAN, Tel Aviv (IL)

(73) Assignee: SCOPIO LABS LTD., Tel Aviv (IL)

(21) Appl. No.: 18/248,553

(22) PCT Filed: Nov. 17, 2021
(86) PCT No.: PCT/IL2021/051366

§ 371 Date: Apr. 11, 2023

Related U.S. Application Data
(60) Provisional application No. 63/114,827, filed on Nov. 17, 2020.

(51) Int. Cl. G06T 7/00; G01N 15/05

(52) U.S. Cl. CPC G06T 7/0012; G01N 15/05; G06T 2207/10056; G06T 2207/30024; G06T 2207/30242; G01N 2015/055

(57) ABSTRACT

A microscope system for detecting a scan area within hematology slides in digital microscopy may include a scanning apparatus to scan a hematology sample, and a processor coupled to the scanning apparatus and a memory. The processor may be configured to execute instructions which may cause the system to receive a first image of the sample at a first resolution and determine a scan area of the sample to scan in response to the first image. The instructions may further cause the system to scan the scan area to generate an image of the scan area at a second resolution greater than the first resolution and classify a plurality of cells from the image of the scan area into cell data comprising a plurality of cell parameters. The instructions may also cause the microscope system to output the cell data. Various other systems and methods are provided.

### RELATED APPLICATIONS

This application claims the benefit under 35 U.S.C. § 119(e) of U.S. Provisional Patent Application No. 63/114,827, filed Nov. 17, 2020, entitled “DETECTING SCAN AREA WITHIN HEMATOLOGY SLIDES IN DIGITAL MICROSCOPY,” which is incorporated, in its entirety, by this reference.

The subject matter of the present application is related to U.S. patent application Ser. No. 15/775,389, filed on Nov. 10, 2016, entitled “Computational microscopes and methods for generating an image under different illumination conditions”, published as US20190235224, U.S. Pat. No. 10,705,326, entitled “Autofocus system for a computational microscope”, and U.S. Pat. No. 10,935,779, entitled “Digital microscope which operates as a server”, U.S. patent application Ser. No. 16/875,665, filed on May 15, 2020, entitled “Multi/parallel scanner”, U.S. patent application Ser. No. 16/875,721, filed on May 15, 2020, entitled “Accelerating digital microscopy scans using empty/dirty area detection”, published as US20200278530, U.S. Pat. No. 10,558,029, entitled “System for image reconstruction using a known pattern”, the entire disclosures of which are incorporated herein by reference.

### BACKGROUND

Prior approaches to analyzing cells and cellular morphology from samples such as blood samples can be less than ideal in at least some respects. For example, prior clinical standards for the review and analysis of blood samples can be based on a compromise between what would be ideal and what can be achieved by a person manually reviewing slides. This can lead to a failure to detect rare cell types and morphology structures, which can lead to a flawed diagnosis in a least some instances. Also, the statistical sampling of prior approaches can be less than ideal because of the limited number of cells that can be analyzed, and in at least some instances diagnoses are made without statistical significance.

Although efforts have been made to improve and/or automate the analysis of cells, the prior approaches have typically analyzed fewer cells and cellular structures than would be ideal, such that the prior automated approaches suffer from shortcomings that are similar to the manual approaches in at least some respects. These shortcomings can be related to the area scanned and the rate at which samples can be scanned at sufficient resolution. Also, the number of cells that can be analyzed at a sufficient rate to be used in a clinical setting may be less than ideal. Work in relation to the present disclosure suggests that the prior approaches to scanning hematology samples may not scan appropriate areas for the type of cells and cellular structure to be analyzed, which may result in the scan taking longer than would be ideal.

In light of the above, it would be desirable to provide improved approaches to analyzing cells that can provide less time-consuming scans of samples and a more accurate analysis of samples to detect diseases and blood conditions. Ideally, an appropriate area would be scanned to provide a sufficient number of cells and cellular structures to decrease the scan time and increase the sensitivity of the analysis and provide statistical significance for the analysis of cell types, morphology and diseases in at least some instances.

### SUMMARY

The presently disclosed systems, methods and apparatuses provide improved scanning and analysis of hematology samples such as blood samples. In some embodiments, a first image is acquired and an area of the sample to be scanned at a high resolution is determined from the first image in order to decrease the amount of time to scan the sample, which can lead to an improved diagnosis. In some embodiments, patient data is received as input to determine the area of the sample to scan. While the patient data may comprise any suitable patient data, in some embodiments the patient data comprises one or more of prior diagnostic data or prior blood sample analysis such as a complete blood count, patient symptom, diagnosis, flow cytometry or other data. In some embodiments, the area scanned is dynamically adjusted in response to the classification of cellular structures, such as cellular structures associated with a rare cell type or disease. The dynamic adjustment to the scan area may occur at any suitable time, such as after the scanning of the sample has started and prior to completion of the scanning of the sample at a resolution suitable to determine and classify cellular structures. This approach can promote scanning of areas that are more likely to have relevant cell data and decreased scan times of other areas.

In some embodiments, microscope system for detecting a scan area within hematology slides in digital microscopy comprises a scanning apparatus to scan a hematology sample, and a processor coupled to the scanning apparatus and a memory. The processor may be configured to execute instructions which cause the system to receive a first image of the sample at a first resolution and determine a scan area of the sample to scan in response to the first image. The instructions may further cause the system to scan the scan area to generate an image of the scan area at a second resolution greater than the first resolution and classify a plurality of cells from the image of the scan area into cell data comprising a plurality of cell parameters. The instructions may also cause the microscope system to output the cell data.

### INCORPORATION BY REFERENCE

All patents, applications, and publications referred to and identified herein are hereby incorporated by reference in their entirety and shall be considered fully incorporated by reference even though referred to elsewhere in the application.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 shows a diagram of an exemplary microscope, in accordance with some embodiments;

FIG. 2 shows a flow chart of an exemplary method, in accordance with some embodiments;

FIGS. 3A-B show example images of samples and potential scan areas in monolayer modes, in accordance with some embodiments;

FIGS. 4A-B show example images of samples and potential scan areas in full field modes, in accordance with some embodiments;

FIG. 5 shows an example granulation measurement, in accordance with some embodiments;

FIG. 6 shows an exemplary computing system, in accordance with some embodiments; and

FIG. 7 shows an exemplary network architecture, in accordance with some embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

Although reference is made to the scanning of hematology samples, embodiments of the present disclosure will find application in many fields where structures such as cells are analyzed, for example bone marrow aspirates, cytology, body fluid samples, histopathology, etc.

The presently disclosed systems, methods and apparatuses are well suited for combination with prior approaches to scanning and analyzing samples such as hematology samples. For example, the optical scanning apparatus may comprise one or more components of a conventional microscope with a sufficient numerical aperture, or a computational microscope as described in U.S. patent application Ser. No. 15/775,389, filed on Nov. 10, 2016, entitled “Computational microscopes and methods for generating an image under different illumination conditions,” published as US20190235224. The system may comprise one or more components of an autofocus system, for example as described in U.S. Pat. No. 10,705,326, entitled “Autofocus system for a computational microscope”. While the system may comprise any suitable user interface and data storage, in some embodiments, the system comprises one or more components for data storage and user interaction as described in U.S. Pat. No. 10,935,779, entitled “Digital microscope which operates as a server”. The system may comprise one or more components of an autoloader for loading slides, for example as described in U.S. patent application Ser. No. 16/875,665, filed on May 15, 2020, entitled “Multi/parallel scanner”. The system may comprise one or more components for selectively scanning areas of a sample, for example as described in U.S. patent application Ser. No. 16/875,721, filed on May 15, 2020, entitled “Accelerating digital microscopy scans using empty/dirty area detection,” published as US20200278530. The system may comprise a grid with a known pattern to facilitate image reconstruction, for example as described in U.S. Pat. No. 10,558,029, entitled “System for image reconstruction using a known pattern”.

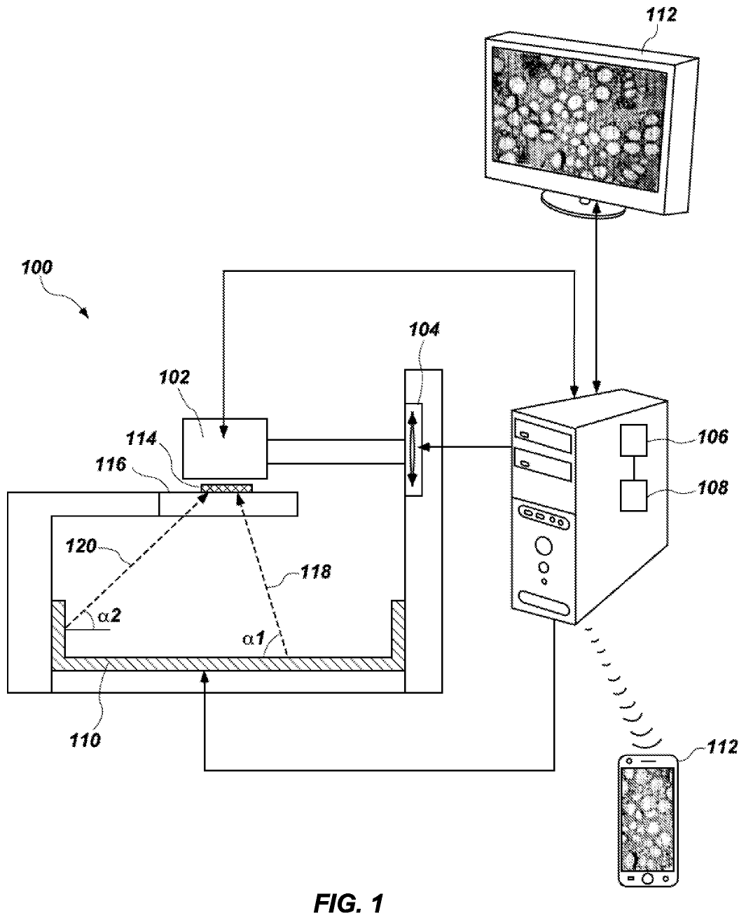

FIG. 1 is a diagrammatic representation of a microscope 100 consistent with the exemplary disclosed embodiments. The term “microscope” as used herein generally refers to any device or instrument for magnifying an object which is smaller than easily observable by the naked eye, i.e., creating an image of an object for a user where the image is larger than the object. One type of microscope may be an “optical microscope” that uses light in combination with an optical system for magnifying an object. An optical microscope may be a simple microscope having one or more magnifying lens. Another type of microscope may be a “computational microscope” that comprises an image sensor and image-processing algorithms to enhance or magnify the object's size or other properties. The computational microscope may be a dedicated device or created by incorporating software and/or hardware with an existing optical microscope to produce high-resolution digital images. As shown in FIG. 1, microscope 100 comprises an image capture device 102, a focus actuator 104, a controller 106 connected to memory 108, an illumination assembly 110, and a user interface 112. An example usage of microscope 100 may be capturing images of a sample 114 mounted on a stage 116 located within the field-of-view (FOV) of image capture device 102, processing the captured images, and presenting on user interface 112 a magnified image of sample 114.

Image capture device 102 may be used to capture images of sample 114. In this specification, the term “image capture device” as used herein generally refers to a device that records the optical signals entering a lens as an image or a sequence of images. The optical signals may be in the near-infrared, infrared, visible, and ultraviolet spectrums. Examples of an image capture device comprise a CCD camera, a CMOS camera, a color camera, a photo sensor array, a video camera, a mobile phone equipped with a camera, a webcam, a preview camera, a microscope objective and detector, etc. Some embodiments may comprise only a single image capture device 102, while other embodiments may comprise two, three, or even four or more image capture devices 102. In some embodiments, image capture device 102 may be configured to capture images in a defined field-of-view (FOV). Also, when microscope 100 comprises several image capture devices 102, image capture devices 102 may have overlap areas in their respective FOVs. Image capture device 102 may have one or more image sensors (not shown in FIG. 1) for capturing image data of sample 114. In other embodiments, image capture device 102 may be configured to capture images at an image resolution higher than VGA, higher than 1 Megapixel, higher than 2 Megapixels, higher than 5 Megapixels, 10 Megapixels, higher than 12 Megapixels, higher than 15 Megapixels, or higher than 20 Megapixels. In addition, image capture device 102 may also be configured to have a pixel size smaller than 15 micrometers, smaller than 10 micrometers, smaller than 5 micrometers, smaller than 3 micrometers, or smaller than 1.6 micrometer.

In some embodiments, microscope 100 comprises focus actuator 104. The term “focus actuator” as used herein generally refers to any device capable of converting input signals into physical motion for adjusting the relative distance between sample 114 and image capture device 102. Various focus actuators may be used, including, for example, linear motors, electrostrictive actuators, electrostatic motors, capacitive motors, voice coil actuators, magnetostrictive actuators, etc. In some embodiments, focus actuator 104 may comprise an analog position feedback sensor and/or a digital position feedback element. Focus actuator 104 is configured to receive instructions from controller 106 in order to make light beams converge to form a clear and sharply defined image of sample 114. In the example illustrated in FIG. 1, focus actuator 104 may be configured to adjust the distance by moving image capture device 102.

However, in other embodiments, focus actuator 104 may be configured to adjust the distance by moving stage 116, or by moving both image capture device 102 and stage 116. Microscope 100 may also comprise controller 106 for controlling the operation of microscope 100 according to the disclosed embodiments. Controller 106 may comprise various types of devices for performing logic operations on one or more inputs of image data and other data according to stored or accessible software instructions providing desired functionality. For example, controller 106 may comprise a central processing unit (CPU), support circuits, digital signal processors, integrated circuits, cache memory, or any other types of devices for image processing and analysis such as graphic processing units (GPUs). The CPU may comprise any number of microcontrollers or microprocessors configured to process the imagery from the image sensors. For example, the CPU may comprise any type of single- or multi-core processor, mobile device microcontroller, etc. Various processors may be used, including, for example, processors available from manufacturers such as Intel®, AMD®, etc. and may comprise various architectures (e.g., x86 processor, ARM®, etc.). The support circuits may be any number of circuits generally well known in the art, including cache, power supply, clock and input-output circuits. Controller 106 may be at a remote location, such as a computing device communicatively coupled to microscope 100.

In some embodiments, controller 106 may be associated with memory 108 used for storing software that, when executed by controller 106, controls the operation of microscope 100. In addition, memory 108 may also store electronic data associated with operation of microscope 100 such as, for example, captured or generated images of sample 114. In one instance, memory 108 may be integrated into the controller 106. In another instance, memory 108 may be separated from the controller 106.

Specifically, memory 108 may refer to multiple structures or computer-readable storage mediums located at controller 106 or at a remote location, such as a cloud server. Memory 108 may comprise any number of random-access memories, read only memories, flash memories, disk drives, optical storage, tape storage, removable storage and other types of storage.

Microscope 100 may comprise illumination assembly 110. The term “illumination assembly” as used herein generally refers to any device or system capable of projecting light to illuminate sample 114.

Illumination assembly 110 may comprise any number of light sources, such as light emitting diodes (LEDs), LED array, lasers, and lamps configured to emit light, such as a halogen lamp, an incandescent lamp, or a sodium lamp. For example, illumination assembly 110 may comprise a Kohler illumination source. Illumination assembly 110 may be configured to emit polychromatic light. For instance, the polychromatic light may comprise white light.

In some embodiments, illumination assembly 110 may comprise only a single light source. Alternatively, illumination assembly 110 may comprise four, sixteen, or even more than a hundred light sources organized in an array or a matrix. In some embodiments, illumination assembly 110 may use one or more light sources located at a surface parallel to illuminate sample 114. In other embodiments, illumination assembly 110 may use one or more light sources located at a surface perpendicular or at an angle to sample 114.

In addition, illumination assembly 110 may be configured to illuminate sample 114 in a series of different illumination conditions. In one example, illumination assembly 110 may comprise a plurality of light sources arranged in different illumination angles, such as a two-dimensional arrangement of light sources. In this case, the different illumination conditions may comprise different illumination angles. For example, FIG. 1 depicts a beam 118 projected from a first illumination angle α1, and a beam 120 projected from a second illumination angle α2. In some embodiments, first illumination angle α1 and second illumination angle α2 may have the same value but opposite sign. In other embodiments, first illumination angle α1 may be separated from second illumination angle α2. However, both angles originate from points within the acceptance angle of the optics. In another example, illumination assembly 110 may comprise a plurality of light sources configured to emit light in different wavelengths. In this case, the different illumination conditions may comprise different wavelengths. For instance, each light source may be configured to emit light with a full width half maximum bandwidth of no more than 50 nm so as to emit substantially monochromatic light. In yet another example, illumination assembly 110 may be configured to use a number of light sources at predetermined times. In this case, the different illumination conditions may comprise different illumination patterns. For example, the light sources may be arranged to sequentially illuminate the sample at different angles to provide one or more of digital refocusing, aberration correction, or resolution enhancement. Accordingly and consistent with the present disclosure, the different illumination conditions may be selected from a group including: different durations, different intensities, different positions, different illumination angles, different illumination patterns, different wavelengths, or any combination thereof.

Although reference is made to computational microscopy, the presently disclosed systems and methods are well suited for use with many types of microscopy and microscopes such as one or more of a high definition microscope, a digital microscope, a scanning digital microscope, a 3D microscope, a phase imaging microscope, a phase contrast microscope, a dark field microscope, a differential interference contrast microscope, a light-sheet microscope, a confocal microscope, a holographic microscope, or a fluorescence-based microscope.

In some embodiments, image capture device 102 may have an effective numerical aperture (“NA”) of at least 0.8. In some embodiments, the effective NA corresponds to a resolving power of the microscope that has the same resolving power as an objective lens with that NA. Image capture device 102 may also have an objective lens with a suitable NA to provide the effective NA, although the NA of the objective lens may be less than the effective NA of the microscope. For example, the imaging apparatus may comprise a computational microscope to reconstruct an image from a plurality of images captured with different illumination angles as described herein, in which the reconstructed image corresponds to an effective NA that is higher than the NA of the objective lens of the image capture device. In some embodiments with conventional microscopes, the NA of the microscope objective corresponds to the effective NA of the images. The lens may comprise any suitable lens such as an oil immersion lens or a non-oil immersion lens.

The dynamic adjustment to the scan area as described herein may occur at any suitable time, such as after the scanning of the sample has started and prior to completion of the scanning of the sample at a resolution suitable to determine and classify cellular structures. This approach can promote scanning of areas that are more likely to have relevant cell data and decreased scan times of other areas. In some embodiments, a first image is generated at a first resolution to determine the area to scan at a second resolution greater than the first resolution, and after scanning of the area at the second resolution has been initiated, the area scanned at the second resolution is adjusted during the scan of the area and prior to completion of the scanning of the sample.

Consistent with disclosed embodiments, microscope 100 may comprise, be connected with, or in communication with (e.g., over a network or wirelessly, e.g., via Bluetooth) user interface 112. The term “user interface” as used herein generally refers to any device suitable for presenting a magnified image of sample 114 or any device suitable for receiving inputs from one or more users of microscope 100. FIG. 1 illustrates two examples of user interface 112. The first example is a smartphone or a tablet wirelessly communicating with controller 106 over a Bluetooth, cellular connection or a Wi-Fi connection, directly or through a remote server. The second example is a PC display physically connected to controller 106. In some embodiments, user interface 112 may comprise user output devices, including, for example, a display, tactile device, speaker, etc. In other embodiments, user interface 112 may comprise user input devices, including, for example, a touchscreen, microphone, keyboard, pointer devices, cameras, knobs, buttons, etc. With such input devices, a user may be able to provide information inputs or commands to microscope 100 by typing instructions or information, providing voice commands, selecting menu options on a screen using buttons, pointers, or eye-tracking capabilities, or through any other suitable techniques for communicating information to microscope 100. User interface 112 may be connected (physically or wirelessly) with one or more processing devices, such as controller 106, to provide and receive information to or from a user and process that information. In some embodiments, such processing devices may execute instructions for responding to keyboard entries or menu selections, recognizing and interpreting touches and/or gestures made on a touchscreen, recognizing and tracking eye movements, receiving and interpreting voice commands, etc.

Microscope 100 may also comprise or be connected to stage 116. Stage 116 comprises any horizontal rigid surface where sample 114 may be mounted for examination. Stage 116 may comprise a mechanical connector for retaining a slide containing sample 114 in a fixed position. The mechanical connector may use one or more of the following: a mount, an attaching member, a holding arm, a clamp, a clip, an adjustable frame, a locking mechanism, a spring or any combination thereof. In some embodiments, stage 116 may comprise a translucent portion or an opening for allowing light to illuminate sample 114. For example, light transmitted from illumination assembly 110 may pass through sample 114 and towards image capture device 102. In some embodiments, stage 116 and/or sample 114 may be moved using motors or manual controls in the XY plane to enable imaging of multiple areas of the sample.

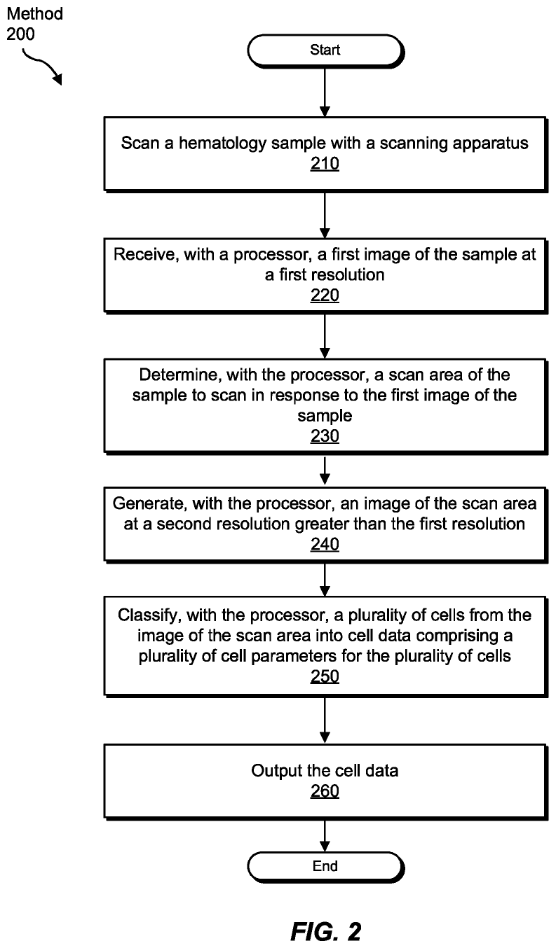

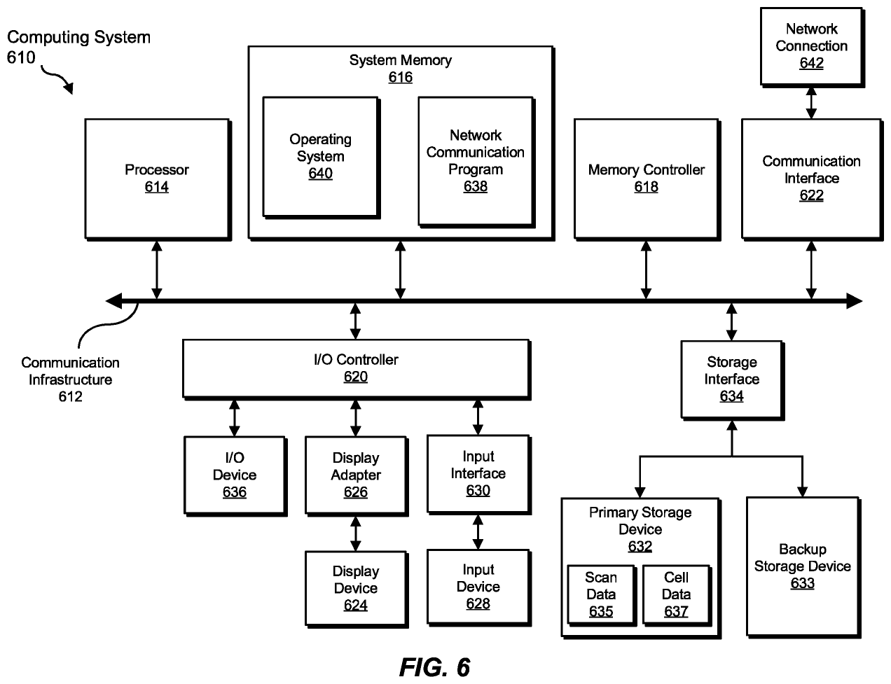

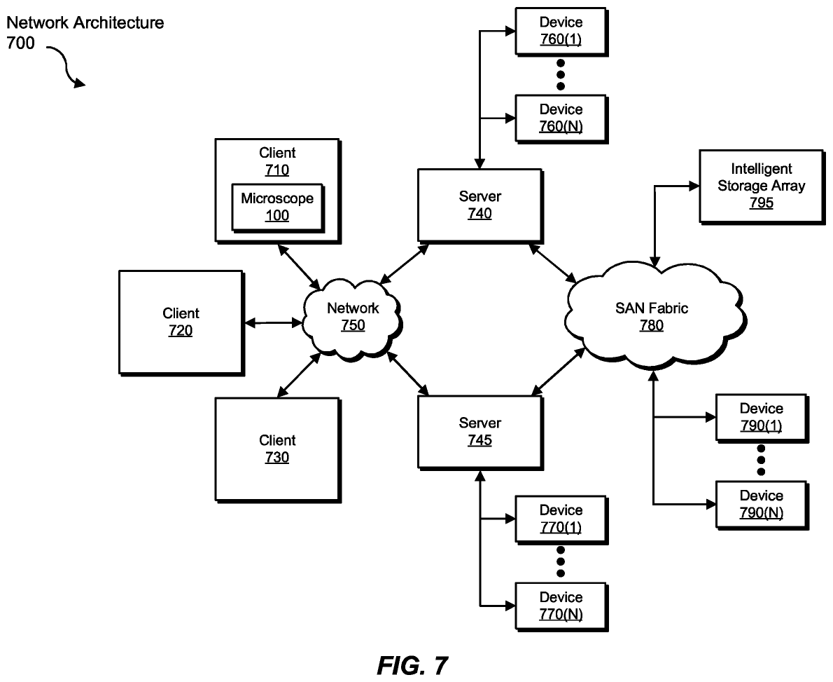

FIG. 2 is a flow diagram of an example computer-implemented method 200 for detecting a scan area within hematology slides in digital microscopy. The steps shown in FIG. 2 may be performed by any suitable computer-executable code and/or computing system, including microscope 100 in FIG. 1, system 600 in FIG. 6, network architecture 700 in FIG. 7, and/or variations or combinations of one or more of the same. In one example, each of the steps shown in FIG. 2 may represent an algorithm whose structure includes and/or is represented by multiple sub-steps, examples of which will be provided in greater detail below.

As illustrated in FIG. 2, at step 210 one or more of the systems described herein may scan a hematology sample with a scanning apparatus. For example, microscope 100 may scan sample 114 with a scanning apparatus (e.g., image capture device 102 in conjunction with focus actuator 104 and illumination assembly 110).

As described herein, in some embodiments the scanning apparatus may comprise an optical microscope configured with a substantially fixed illumination light source to capture a plurality of images of the sample. Optionally, in some embodiments, the scanning apparatus may sequentially acquire the plurality of images from different areas of the sample.

As described herein, in some embodiments the scanning apparatus may comprise a computational microscope configured to vary a light source with a plurality of illumination angles to capture a plurality of images of the sample. Optionally, in some embodiments the plurality of images may be processed to generate a high resolution image of the area.

The sample, which may be a hematology sample or blood sample, may include various particular components. For example, the hematology sample may comprise a body, a monolayer of cells and a feathered edge.

The systems described herein may receive additional signals that may aid in scan area detection described further below. For example, microscope 100 may receive patient data prior to scanning sample 114. The patient data may include various types of data that may be relevant to scanning sample 114. For example, the patient data may comprise one or more of flow cytometry data from a flow cytometer or a complete blood count (“CBC”) from a CBC machine. The flow cytometry data may comprise a platelet count.

In some embodiments, the patient data may comprise one or more of a complete blood count (“CBC”), a white blood cell (“WBC”) count, a WBC differential count, a red blood cell (“RBC”) count, or a platelet count. Optionally, in some embodiments the WBC differential count may comprise relative amounts of neutrophils, eosinophils, basophils, lymphocytes and monocytes.

In some embodiments, the patient data may comprise prior diagnostic data of the patient. For example, the prior diagnostic data may comprise the WBC differential count. In some embodiments, the WBC differential count may comprise one or more cell types outside a normal range.

In some embodiments, the patient data may correspond to an abnormal cell type. In some embodiments, the patient data may correspond to an anemia of the patient.

At step 220, one or more of the systems described herein may receive, with a processor, a first image of the sample at a first resolution. For example, microscope 100 (e.g., controller 106), may receive a first image of sample 114 at a first resolution.

The first image may, in some embodiments, prioritize fast acquisition over high resolutions. For example, the first image may comprise one or more of a preview image, a webcam image, or an image from the scanning apparatus.

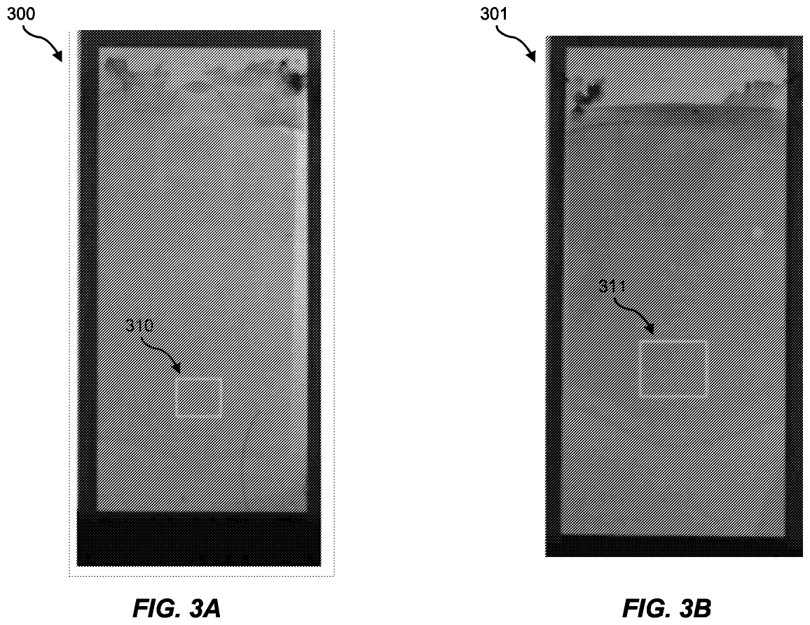

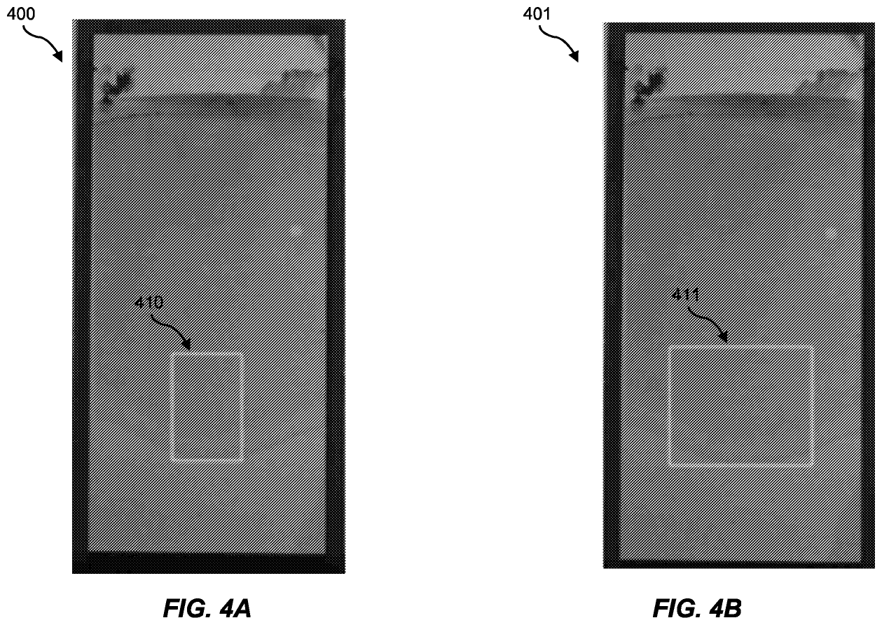

FIG. 3A illustrates an example first image 300 of a blood smear using, for instance, a preview camera. FIG. 3B illustrates an example first image 301 of a blood smear using a preview camera. FIG. 4A illustrates an example first image 400 of a blood smear using a preview camera. FIG. 4B illustrates an example first image 401 of a blood smear using a preview camera.

In some embodiments, the first image may comprise a plurality of first images captured over different fields of view. For instance, the plurality of first images may comprise no more than two images. Optionally, the plurality of first images may comprise fewer than 5 images, optionally fewer than 10 images, optionally fewer than 20 images, or optionally fewer than 50 images.

Turning back to FIG. 2, at step 230 one or more of the systems described herein may determine, with the processor, a scan area of the sample to scan in response to the first image of the sample. For example, microscope 100 (e.g., controller 106) may determine a scan area of the sample to scan in response to the first image of sample 114. In some examples, the scan area (e.g., size and location of the scan area with the first image), may be determined according to different modes of scanning, as will be described further below.

Microscope 100 may determine the scan area based on various attributes relating to sample 114 as may be detected from the first image. For example, when sample 114 comprises a body, a monolayer of cells and a feathered edge, microscope 100 may select the scan area in response to one or more of a location of the body, a location of the monolayer of cells, or a location of the feathered edge. FIGS. 3A-B and 4A-B may correspond to respective monolayers of cells, which will be discussed further below.

In some embodiments, microscope 100 may determine the scan area in response to one or more of identified locations of cells in the first image, a density of cells in an area of the first image, or relative densities of cells at different areas of the first image.

The scan area may be determined to meet particular requirements. For example, the scan area may comprise at least 0.4 cm² and an optical resolution of the image of the scan area may be within a range from about 200 nm to about 500 nm. Optionally, the scan area may be within a range from about 200 nm to about 400 nm.

In some embodiments, microscope 100 may dynamically adjust the scan area to scan in response to cell data from the image of the scan area, as will be described further below.

In some embodiments, when patient data is received prior to scanning the sample, the scan area may be determined using the patient data. For example, when the patient data comprises the WBC differential count, microscope 100 may determine the scan area in response to cell counts of the WBC differential count. In other examples, when the WBC differential count comprises one or more cell types outside a normal range, microscope 100 may determine an area of the sample having an increased likelihood of presence for the one or more cell types outside the normal range.

In some embodiments, when the patient data corresponds to an anemia of the patient, microscope 100 may increase the scan area to detect one or more of tear drop cells or dacrocytes or one or more of schistocytes.

In some embodiments, microscope 100 may define the scan area to classify a plurality of platelets for a platelet count and platelet morphology. In some embodiments, the scan area may comprise a feathered edge of the sample. In some embodiments, the scan area may comprise the feathered edge of the sample in response to a low platelet count.

In some embodiments, the scan area may comprise a scan area to classify a plurality of WBCs for a WBC differential count. In some embodiments, the scan area may comprise a scan area to classify a plurality of RBCs for an RBC count.

In some embodiments, when the patient data corresponds to an abnormal cell type, microscope 100 may adjust the scan area in response to the abnormal cell type.

In some embodiments, the scan area may comprise an area to detect parasites.

In some embodiments, microscope 100 may receive additional criteria for determining the scan area by way of a user input. For example, microscope 100 may receive a user input that may correspond to a type of cell to analyze. In such embodiments, microscope 100 may determine the scan area in response to the user input. Further, the type of cell to analyze may comprise one or more of a red blood cell count, a platelet count, a platelet morphology, a WBC count, a WBC differential count, a bone marrow megakaryocyte count, or a parasite detection.

In some embodiments, microscope 100 may scan a plurality of samples in an automated mode and microscope 100 may enter a manual mode of operation to receive a user input. For example, a user of microscope 100 may use user interface 112 to enter user inputs.

FIG. 3A may correspond to a rapid monolayer mode, which may be a fast mode designed to obtain, for example, 100 WBCs to produce a faster scan (e.g., by scanning a smaller area compared to that of a default or otherwise more detailed scan). Based on these criteria, a scan area 310 may be appropriately sized. FIG. 3B may correspond to a default mode that may be designed to obtain, for example, 200 WBCs. As such, a scan area 311 may be selected. Scan area 310 may be sized smaller than scan area 311 in order to produce a faster scan.

FIGS. 4A-B may correspond to full field modes for producing scans including more information for full field analysis (e.g., full field morphology testing). More specifically, FIG. 4A may correspond to a full field mode designed to obtain, for example, at least 200 WBCs in the monolayer and further to present a scan of the feathered edge area that may be relevant, for instance, in cases of suspected platelet clumps or suspected abnormally large cells. A scan area 410 may be accordingly selected to fit these criteria. FIG. 4B may correspond to a full field cytopenic mode, which may be similar to the full field mode (e.g., in FIG. 4A) but may select a larger scan area for cases in which cytopenia is suspected. Thus, a scan area 411 may be appropriately selected, which may be larger than scan area 410.

Returning to FIG. 2, at step 240 one or more of the systems described herein may generate, with the processor, an image of the scan area at a second resolution greater than the first resolution. For example, microscope 100 (e.g., controller 106) may generate an image of the scan area at a second resolution greater than the first resolution.

In some embodiments, the scan area may comprise at least 0.4 cm² and an optical resolution of the image of the scan area may be within a range from about 200 nm to about 500 nm. Optionally, the scan area may be within a range from about 200 nm to about 400 nm. In some embodiments, a pixel resolution of the image of the scan area may be within a range from about 100 nm to about 250 nm and optionally within a range from about 100 nm to about 200 nm.

At step 250 one or more of the systems described herein may classify, with the processor, a plurality of cells from the image of the scan area into cell data comprising a plurality of cell parameters for the plurality of cells. For example, microscope 100 (e.g., controller 106) may classify a plurality of cells from the image of the scan area into cell data comprising a plurality of cells from the image of the scan area into cell data that may comprise a plurality of cell parameters for the plurality of cells.

As described above, in some embodiments microscope 100 may adjust the scan area. For example, as microscope 100 receives and/or analyzes data, microscope 100 may accordingly adjust the scan area. In some embodiments, microscope 100 may repeat one or more steps of method 200 and/or perform one or more steps of method 200 in parallel.

In some embodiments, microscope 100 may dynamically adjust the scan area such that the scan area may be updated while microscope 100 performs one or more steps of method 200. For example, microscope 100 may dynamically adjust the scan area in response to a gradient of cells in the area.

In some embodiments, microscope 100 may dynamically adjust the scan area from a first area scanned with the scanning apparatus to a second area not yet scanned with the scanning apparatus in response to the cell data. For instance, the first area may not overlap with the second area. Optionally in some examples, a gap may extend between the first area and the second area such that the scanning apparatus may skip scanning the sample between the first area and the second area. For instance, microscope 100 may skip scanning the gap (e.g., by controlling and/or moving one or more of focus actuator 104, stage 116, image capture device 102, etc.).

In some embodiments, microscope 100 may classify the plurality of cell parameters during the scan of the scan area and microscope 100 may dynamically adjust the scan of the scan area in response to the plurality of cell parameters. Optionally in some examples, the plurality of cell parameters may comprise a plurality of cell types.

In some embodiments, microscope 100 may classify the plurality cell parameters with an artificial intelligence (AI) algorithm during the scan of the scan area. For instance, the AI algorithm comprises on or more of a statistical classifier or a neural network classifier. In some embodiments, microscope 100 may process at least 10 classifiers in parallel with each other and with the scanning of the scan area.

The artificial intelligence used to classify the parameters may be configured in any suitable way in accordance with the present disclosure. In some embodiments, the artificial intelligence may comprise a neural network classifier, e.g. a convolutional neural network, or a machine learning classifier, for example. The classifier may include one or more models such as a neural network, a convolutional neural network, decision trees, support vector machines, regression analysis, Bayesian networks, and/or training models. The classifier may be configured to classify the at least 10 parameters as described herein with any of the aforementioned approaches. In some embodiments, the classifier may comprise a convolutional neural network with several cascaded layers for detection and segmentation. In some embodiments, the classifier may comprise a binary classification parameter or a multi-level classification parameter. The various steps may be performed sequentially or in parallel. For example, cell types may be classified, and then cellular morphology parameters classified based on a cell type. In some embodiments, a plurality of parameters may be classified and output to determine cell type, and additional parameters may be selected and classified based on cell type. In some embodiments, groups of cells or parameters may be classified, and these groups may further be classified into subgroups, which may be used to classify other subgroups. In some embodiments, cellular structures may be segmented to provide segmented cellular images. Alternatively, cells and parameters may be classified without segmentation. In some embodiments, combinations of logical operations may be performed on the output parameters to determine additional parameters to classify and associated processes, such as logical operations related to detected morphology structures. A person of ordinary skill in the art in of artificial intelligence will recognize many adaptations and variations for classifying and determining parameters in accordance with the present disclosure.

In some embodiments, microscope 100 may detect and count a number of red blood cells over at least a portion of the scan area and microscope 100 may adjust the scan area in response to the number of detected red blood cells. Optionally in some examples, the number may comprise a number per unit area and optionally microscope 100 may adjust the scan area in response to a number of non-overlapping red blood cells.

In some embodiments, microscope 100 may detect and count a number of white blood cells over at least a portion of the scan area and microscope 100 may adjust the scan area in response to the number of detected white blood cells. Optionally in some examples, the number may comprise a number per unit area.

In some embodiments, the cell data may comprise one or more of a cell type, a rare cell type, a density of cells of a cell type, a number of cells of a cell type, or a target number of cells of a cell type. For instance, the rare cell type may comprise one or more of a blast cell, a plasma cell, a myelocyte or a promyelocyte, a circulating lymphoma cell, an immature cell, a hairy cell a binucleated cell (“buttocks cell”), a Sezary cell, or a cup-like blast. In some embodiments, microscope 100 may increase the scan area in response to the rare cell type. Optionally in some examples, the rare cell type may comprise an abnormal cell type.

In some embodiments, the plurality of cell parameters may comprise a parameter corresponding to a size of a cell and microscope 100 may adjust the scan area to scan a feathered edge of the sample in response to the size of the cell. In some embodiments, the cell may comprise a distance across greater than 20 um and optionally microscope 100 may adjust the scan area from a monolayer or a body of the sample to the feathered edge in response to the size of the cell.

In some embodiments, microscope 100 may adjust the scan area to an edge of the sample in response to a platelet count below a threshold value. In some embodiments, microscope 100 may detect clumped platelets and optionally the plurality of cell parameters may comprise a clumped platelet parameter.

In some embodiments, microscope 100 may increase the scan area in response to a WBC count below a threshold value and optionally microscope 100 may decrease the scan area in response to the WBC count above a threshold value.

In some embodiments, the plurality of cell parameters may comprise one or more of a total WBC count or a count of a type of WBC and microscope 100 may adjust the scan area in response to the one or more of the total WBC count or the count of the type of WBC. In some embodiments, microscope 100 may increase the scan area in response to the one or more of the total WBC count or the count of the type of WBC below a threshold value.

Returning to FIG. 2, at step 260 one or more of the systems described herein may output the cell data. For example, microscope 100 may output the cell data via user interface 112 and/or another computing device.

In some embodiments, when the cell data is output to user interface 112, the cell data may comprise one or more of cell statistics, cell counts, cell populations, cell types, parasites, or a digital scan image. In some embodiments, the digital scan image may be presented with a size and resolution suitable for the user to select a cell in the image and present data for the cell in response to the user selecting the cell.

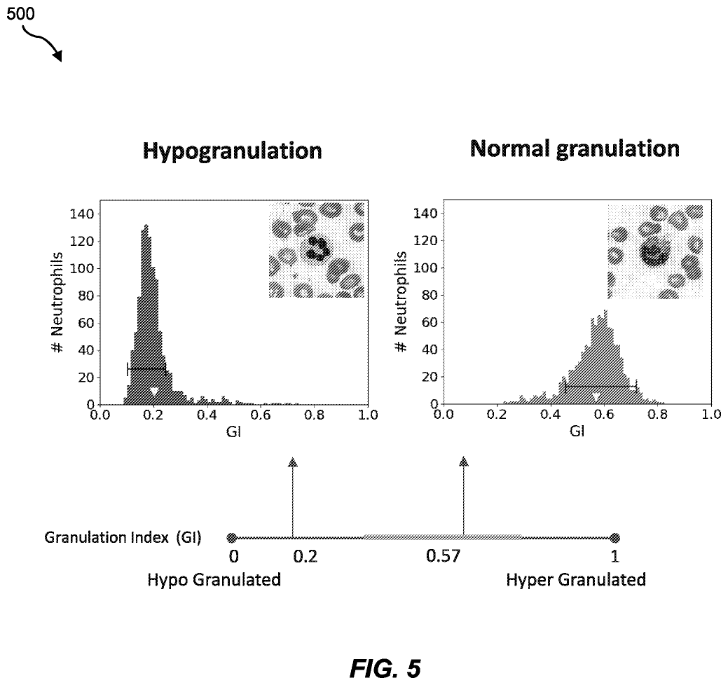

FIG. 5 illustrates an output 500, which may include statistical data arranged in graphs along with related image data of cells.

In some embodiments, microscope 100 (e.g., user interface 112), may present an image of the clumped platelets to the user to verify detection and classification of the clumped platelets. In some embodiments, microscope 100 may present additional data and/or image to the user in response to user inputs, and may further verify detection, classification, and/or other analyzed data based on user input.

As described herein, microscope 100 may perform the steps of method 200 sequentially in any order and/or in parallel and may repeat steps as needed. For example, microscope 100 may repeat certain steps in response to analyzed data and/or user inputs, such as for dynamically adjusting the scan area.

FIG. 6 is a block diagram of an example computing system 610 capable of implementing one or more of the embodiments described and/or illustrated herein. For example, all or a portion of computing system 610 may perform and/or be a means for performing, either alone or in combination with other elements, one or more of the steps described herein (such as one or more of the steps illustrated in FIG. 2). All or a portion of computing system 610 may also perform and/or be a means for performing any other steps, methods, or processes described and/or illustrated herein. All or a portion of computing system 610 may correspond to or otherwise be integrated with microscope 100 (e.g., one or more of controller 106, memory 108, and/or user interface 112).

Computing system 610 broadly represents any single or multi-processor computing device or system capable of executing computer-readable instructions. Examples of computing system 610 include, without limitation, workstations, laptops, client-side terminals, servers, distributed computing systems, handheld devices, or any other computing system or device. In its most basic configuration, computing system 610 may include at least one processor 614 and a system memory 616.

Processor 614 generally represents any type or form of physical processing unit (e.g., a hardware-implemented central processing unit) capable of processing data or interpreting and executing instructions. In certain embodiments, processor 614 may receive instructions from a software application or module. These instructions may cause processor 614 to perform the functions of one or more of the example embodiments described and/or illustrated herein.

System memory 616 generally represents any type or form of volatile or non-volatile storage device or medium capable of storing data and/or other computer-readable instructions. Examples of system memory 616 include, without limitation, Random Access Memory (RAM), Read Only Memory (ROM), flash memory, or any other suitable memory device. Although not required, in certain embodiments computing system 610 may include both a volatile memory unit (such as, for example, system memory 616) and a non-volatile storage device (such as, for example, primary storage device 632, as described in detail below). In one example, one or more of steps from FIG. 2 may be computer instructions that may be loaded into system memory 616.

In some examples, system memory 616 may store and/or load an operating system 640 for execution by processor 614. In one example, operating system 640 may include and/or represent software that manages computer hardware and software resources and/or provides common services to computer programs and/or applications on computing system 610. Examples of operating system 640 include, without limitation, LINUX, JUNOS, MICROSOFT WINDOWS, WINDOWS MOBILE, MAC OS, APPLE'S IOS, UNIX, GOOGLE CHROME OS, GOOGLE'S ANDROID, SOLARIS, variations of one or more of the same, and/or any other suitable operating system.

In certain embodiments, example computing system 610 may also include one or more components or elements in addition to processor 614 and system memory 616. For example, as illustrated in FIG. 6, computing system 610 may include a memory controller 618, an Input/Output (I/O) controller 620, and a communication interface 622, each of which may be interconnected via a communication infrastructure 612. Communication infrastructure 612 generally represents any type or form of infrastructure capable of facilitating communication between one or more components of a computing device. Examples of communication infrastructure 612 include, without limitation, a communication bus (such as an Industry Standard Architecture (ISA), Peripheral Component Interconnect (PCI), PCI Express (PCIe), or similar bus) and a network.

Memory controller 618 generally represents any type or form of device capable of handling memory or data or controlling communication between one or more components of computing system 610. For example, in certain embodiments memory controller 618 may control communication between processor 614, system memory 616, and I/O controller 620 via communication infrastructure 612.

I/O controller 620 generally represents any type or form of module capable of coordinating and/or controlling the input and output functions of a computing device. For example, in certain embodiments I/O controller 620 may control or facilitate transfer of data between one or more elements of computing system 610, such as processor 614, system memory 616, communication interface 622, display adapter 626, input interface 630, and storage interface 634.

As illustrated in FIG. 6, computing system 610 may also include at least one display device 624 (which may correspond to user interface 112) coupled to I/O controller 620 via a display adapter 626. Display device 624 generally represents any type or form of device capable of visually displaying information forwarded by display adapter 626. Similarly, display adapter 626 generally represents any type or form of device configured to forward graphics, text, and other data from communication infrastructure 612 (or from a frame buffer, as known in the art) for display on display device 624.

As illustrated in FIG. 6, example computing system 610 may also include at least one input device 628 (which may correspond to user interface 112) coupled to I/O controller 620 via an input interface 630. Input device 628 generally represents any type or form of input device capable of providing input, either computer or human generated, to example computing system 610. Examples of input device 628 include, without limitation, a keyboard, a pointing device, a speech recognition device, variations or combinations of one or more of the same, and/or any other input device.

Additionally or alternatively, example computing system 610 may include additional I/O devices. For example, example computing system 610 may include I/O device 636. In this example, I/O device 636 may include and/or represent a user interface that facilitates human interaction with computing system 610. Examples of I/O device 636 include, without limitation, a computer mouse, a keyboard, a monitor, a printer, a modem, a camera, a scanner, a microphone, a touchscreen device, variations or combinations of one or more of the same, and/or any other I/O device.

Communication interface 622 broadly represents any type or form of communication device or adapter capable of facilitating communication between example computing system 610 and one or more additional devices. For example, in certain embodiments communication interface 622 may facilitate communication between computing system 610 and a private or public network including additional computing systems. Examples of communication interface 622 include, without limitation, a wired network interface (such as a network interface card), a wireless network interface (such as a wireless network interface card), a modem, and any other suitable interface. In at least one embodiment, communication interface 622 may provide a direct connection to a remote server via a direct link to a network, such as the Internet. Communication interface 622 may also indirectly provide such a connection through, for example, a local area network (such as an Ethernet network), a personal area network, a telephone or cable network, a cellular telephone connection, a satellite data connection, or any other suitable connection.

In certain embodiments, communication interface 622 may also represent a host adapter configured to facilitate communication between computing system 610 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 622 may also allow computing system 610 to engage in distributed or remote computing. For example, communication interface 622 may receive instructions from a remote device or send instructions to a remote device for execution.

In some examples, system memory 616 may store and/or load a network communication program 638 for execution by processor 614. In one example, network communication program 638 may include and/or represent software that enables computing system 610 to establish a network connection 642 with another computing system (not illustrated in FIG. 6) and/or communicate with the other computing system by way of communication interface 622. In this example, network communication program 638 may direct the flow of outgoing traffic that is sent to the other computing system via network connection 642. Additionally or alternatively, network communication program 638 may direct the processing of incoming traffic that is received from the other computing system via network connection 642 in connection with processor 614.

Although not illustrated in this way in FIG. 6, network communication program 638 may alternatively be stored and/or loaded in communication interface 622. For example, network communication program 638 may include and/or represent at least a portion of software and/or firmware that is executed by a processor and/or Application Specific Integrated Circuit (ASIC) incorporated in communication interface 622.

As illustrated in FIG. 6, example computing system 610 may also include a primary storage device 632 and a backup storage device 633 coupled to communication infrastructure 612 via a storage interface 634. Storage devices 632 and 633 generally represent any type or form of storage device or medium capable of storing data and/or other computer-readable instructions. For example, storage devices 632 and 633 may be a magnetic disk drive (e.g., a so-called hard drive), a solid state drive, a floppy disk drive, a magnetic tape drive, an optical disk drive, a flash drive, or the like. Storage interface 634 generally represents any type or form of interface or device for transferring data between storage devices 632 and 633 and other components of computing system 610. In one example, scan data 635 (which may correspond to the scan data described herein) and/or cell data 637 (which may correspond to the cell data described herein) may be stored and/or loaded in primary storage device 632.

In certain embodiments, storage devices 632 and 633 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 632 and 633 may also include other similar structures or devices for allowing computer software, data, or other computer-readable instructions to be loaded into computing system 610. For example, storage devices 632 and 633 may be configured to read and write software, data, or other computer-readable information. Storage devices 632 and 633 may also be a part of computing system 610 or may be a separate device accessed through other interface systems.

Many other devices or subsystems may be connected to computing system 610. Conversely, all of the components and devices illustrated in FIG. 6 need not be present to practice the embodiments described and/or illustrated herein. The devices and subsystems referenced above may also be interconnected in different ways from that shown in FIG. 6. Computing system 610 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 610. All or a portion of the computer program stored on the computer-readable medium may then be stored in system memory 616 and/or various portions of storage devices 632 and 633. When executed by processor 614, a computer program loaded into computing system 610 may cause processor 614 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 610 may be configured as an Application Specific Integrated Circuit (ASIC) adapted to implement one or more of the example embodiments disclosed herein.

FIG. 7 is a block diagram of an example network architecture 700 in which client systems 710, 720, and 730 and servers 740 and 745 may be coupled to a network 750. As detailed above, all or a portion of network architecture 700 may perform and/or be a means for performing, either alone or in combination with other elements, one or more of the steps disclosed herein (such as one or more of the steps illustrated in FIG. 2). All or a portion of network architecture 700 may also be used to perform and/or be a means for performing other steps and features set forth in the instant disclosure.

Client systems 710, 720, and 730 generally represent any type or form of computing device or system, such as example computing system 610 in FIG. 6. Similarly, servers 740 and 745 generally represent computing devices or systems, such as application servers or database servers, configured to provide various database services and/or run certain software applications. Network 750 generally represents any telecommunication or computer network including, for example, an intranet, a WAN, a LAN, a PAN, or the Internet. In one example, client systems 710, 720, and/or 730 and/or servers 740 and/or 745 may include all or a portion of microscope 100 from FIG. 1.

As illustrated in FIG. 7, one or more storage devices 760(1)-(N) may be directly attached to server 740. Similarly, one or more storage devices 770(1)-(N) may be directly attached to server 745. Storage devices 760(1)-(N) and storage devices 770(1)-(N) generally represent any type or form of storage device or medium capable of storing data and/or other computer-readable instructions. In certain embodiments, storage devices 760(1)-(N) and storage devices 770(1)-(N) may represent Network-Attached Storage (NAS) devices configured to communicate with servers 740 and 745 using various protocols, such as Network File System (NFS), Server Message Block (SMB), or Common Internet File System (CIFS).

Servers 740 and 745 may also be connected to a Storage Area Network (SAN) fabric 780. SAN fabric 780 generally represents any type or form of computer network or architecture capable of facilitating communication between a plurality of storage devices. SAN fabric 780 may facilitate communication between servers 740 and 745 and a plurality of storage devices 790(1)-(N) and/or an intelligent storage array 795. SAN fabric 780 may also facilitate, via network 750 and servers 740 and 745, communication between client systems 710, 720, and 730 and storage devices 790(1)-(N) and/or intelligent storage array 795 in such a manner that devices 790(1)-(N) and array 795 appear as locally attached devices to client systems 710, 720, and 730. As with storage devices 760(1)-(N) and storage devices 770(1)-(N), storage devices 790(1)-(N) and intelligent storage array 795 generally represent any type or form of storage device or medium capable of storing data and/or other computer-readable instructions.

In certain embodiments, and with reference to example computing system 610 of FIG. 6, a communication interface, such as communication interface 622 in FIG. 6, may be used to provide connectivity between each client system 710, 720, and 730 and network 750. Client systems 710, 720, and 730 may be able to access information on server 740 or 745 using, for example, a web browser or other client software. Such software may allow client systems 710, 720, and 730 to access data hosted by server 740, server 745, storage devices 760(1)-(N), storage devices 770(1)-(N), storage devices 790(1)-(N), or intelligent storage array 795. Although FIG. 7 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 740, server 745, storage devices 760(1)-(N), storage devices 770(1)-(N), storage devices 790(1)-(N), intelligent storage array 795, or any combination thereof. All or a portion of one or more of the example embodiments disclosed herein may also be encoded as a computer program, stored in server 740, run by server 745, and distributed to client systems 710, 720, and 730 over network 750.

As detailed above, computing system 610 and/or one or more components of network architecture 700 may perform and/or be a means for performing, either alone or in combination with other elements, one or more steps of an example method for bone marrow aspirate analysis.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor. The processor may comprise a distributed processor system, e.g. running parallel processors, or a remote processor such as a server, and combinations thereof.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

It will be understood that although the terms “first,” “second,” “third”, etc. may be used herein to describe various layers, elements, components, regions or sections without referring to any particular order or sequence of events. These terms are merely used to distinguish one layer, element, component, region or section from another layer, element, component, region or section. A first layer, element, component, region or section as described herein could be referred to as a second layer, element, component, region or section without departing from the teachings of the present disclosure.

As used herein, the term “or” is used inclusively to refer items in the alternative and in combination.

As used herein, characters such as numerals refer to like elements.

The present disclosure includes the following numbered clauses.
Clause 1. A system for scanning a hematology sample of a patient, the system comprising: a scanning apparatus to scan the hematology sample; a processor coupled to the scanning apparatus and a memory and configured to execute instructions which cause the system to: receive a first image of the sample at a first resolution; determine a scan area of the sample to scan in response to the first image of the sample; scan the scan area to generate an image of the scan area at a second resolution greater than the first resolution; classify a plurality of cells from the image of the scan area into cell data comprising a plurality of cell parameters for the plurality of cells; and output the cell data.
Clause 2. The system of clause 1, wherein the scan area comprises at least 0.4 cm² and an optical resolution of the image of the scan area is within a range from about 200 nm to about 500 nm and optionally within a range from about 200 nm to about 400 nm.
Clause 3. The system of clause 2, wherein a pixel resolution of the image of the scan area is within a range from about 100 nm to about 250 nm and optionally within a range from about 100 nm to about 200 nm.
Clause 4. The system of clause 1, wherein the hematology sample comprises a body, a monolayer of cells and a feathered edge and wherein, the processor is configured to select the scan area in response to one or more of a location of the body, a location of the monolayer of cells, or a location of the feathered edge.
Clause 5. The system of clause 1, wherein the first image comprises one or more of a preview image, a webcam image, or an image from the scanning apparatus.
Clause 6. The system of clause 5, wherein the first image comprises a plurality of first images captured over different fields of view, the plurality of first images comprising no more than two images, and optionally fewer than 5 images, optionally fewer than 10 images, optionally fewer than 20 images, or optionally fewer than 50 images.
Clause 7. The system of clause 5, wherein the processor is configured to determine the scan area in response to one or more of identified locations of cells in the first image, a density of cells in an area of the first image, or relative densities of cells at different areas of the first image.
Clause 8. The system of clause 1, wherein the processor is configured to dynamically adjust the scan area to scan in response to cell data from the image of the scan area.
Clause 9. The system of clause 8, wherein the processor is configured to detect and count a number of red blood cells over at least a portion of the scan area and to adjust the scan area in response to the number of detected red blood cells and optionally wherein the number comprises a number per unit area and optionally wherein the scan area is adjusted in response to a number of non-overlapping red blood cells.
Clause 10. The system of clause 8, wherein the processor is configured to detect and count a number of white blood cells over at least a portion of the scan area and to adjust the scan area in response to the number of detected white blood cells and optionally wherein the number comprises a number per unit area.
Clause 11. The system of clause 8, wherein the processor is configured to classify the plurality of cell parameters during the scan of the scan area and to dynamically adjust the scan of the scan area in response to the plurality of cell parameters and optionally wherein the plurality of cell parameters comprises a plurality of cell types.
Clause 12. The system of clause 11, wherein the processor is configured to classify the plurality of cell parameters with an artificial intelligence (AI) algorithm during the scan of the scan area.
Clause 13. The system of clause 12, wherein the AI algorithm comprises on or more of a statistical classifier or a neural network classifier.
Clause 14. The system of clause 12, wherein the processor is configured to run at least 10 classifiers in parallel with each other and with the scanning of the scan area.
Clause 15. The system of clause 8, wherein the processor is configured to dynamically adjust the scan area in response to a gradient of cells in the scan area.
Clause 16. The system of clause 8, wherein the processor is configured to dynamically adjust the scan area from a first area scanned with the scanning apparatus to a second area not yet scanned with the scanning apparatus in response to the cell data.
Clause 17. The system of clause 16, wherein the first area does not overlap with the second area and optionally wherein a gap extends between the first area and the second area and the processor is configured to skip scanning of the sample with the scanning apparatus between the first area and the second area.
Clause 18. The system of clause 8, wherein the cell data comprises one or more of a cell type, a rare cell type, a density of cells of a cell type, a number of cells of a cell type, or a target number of cells of a cell type.
Clause 19. The system of clause 18, wherein the rare cell type comprises one or more of a blast cell, a plasma cell, a myelocyte or a promyelocyte, a circulating lymphoma cell, an immature cell, a hairy cell a binucleated cell (“buttocks cell”), a Sezary cell, or a cup-like blast.
Clause 20. The system of clause 19, wherein the processor is configured to increase the scan area in response to the rare cell type and optionally wherein the rare cell type comprises an abnormal cell type.
Clause 21. The system of clause 8, wherein the plurality of cell parameters comprises a parameter corresponding to a size of a cell and wherein the processor is configured to adjust the scan area to scan a feathered edge of the sample in response to the size of the cell.
Clause 22. The system of clause 21, wherein the cell comprises a distance across greater than 20 um and optionally wherein the processor is configured to adjust the scan area from a monolayer or a body of the sample to the feathered edge in response to the size of the cell.
Clause 23. The system of clause 8, wherein the processor is configured to adjust the scan area to an edge of the sample in response to a platelet count below a threshold value.
Clause 24. The system of clause 8, wherein the processor is configured to increase the scan area in response to a WBC count below a threshold value and optionally decrease the scan area in response to the WBC count above a threshold value.
Clause 25. The system of clause 8, wherein the plurality of cell parameters comprises one or more of a total WBC count or a count of a type of WBC and wherein the processor is configured to adjust the scan area in response to the one or more of the total WBC count or the count of the type of WBC.
Clause 26. The system of clause 25, wherein the processor is configured to increase the scan area in response to the one or more of the total WBC count or the count of the type of WBC below a threshold value.
Clause 27. The system of clause 1, wherein the processor is configured to receive patient data prior to scanning the sample.
Clause 28. The system of clause 27, wherein the patient data comprises one or more of flow cytometry data from a flow cytometer or a complete blood count (“CBC”) from a CBC machine.
Clause 29. The system of clause 28, wherein the flow cytometry data comprises a platelet count.
Clause 30. The system of clause 27, wherein the patient data comprises one or more of a complete blood count (“CBC”), a white blood cell (“WBC”) count, a WBC differential count, a red blood cell (“RBC”) count, or a platelet count and optionally wherein the WBC differential count comprises relative amounts of neutrophils, eosinophils, basophils, lymphocytes and monocytes.
Clause 31. The system of clause 30, wherein the patient data comprises prior diagnostic data of the patient.
Clause 32. The system of clause 31, wherein the prior diagnostic data comprises the WBC differential count and the area is determined in response to cell counts of the WBC differential count.
Clause 33. The system of clause 32, wherein the WBC differential count comprises one or more cell types outside a normal range and the processor is configured to determine an area of the sample having an increased likelihood of presence for the one or more cell types outside the normal range.
Clause 34. The system of clause 27, wherein the scan area is defined to classify a plurality of platelets for a platelet count and platelet morphology.
Clause 35. The system of clause 34, wherein the scan area comprises a feathered edge of the sample.
Clause 36. The system of clause 35 wherein the scan area comprises the feathered edge of the sample in response to a low platelet count.
Clause 37. The system of clause 35, wherein the processor is configured to detect clumped platelets and optionally wherein the plurality of cell parameters comprises a clumped platelet parameter.
Clause 38. The system of clause 37, wherein the processor is configured to present an image of the clumped platelets to a user to verify detection and classification of the clumped platelets.
Clause 39. The system of clause 27, wherein the scan area comprises a scan area to classify a plurality of WBCs for a WBC differential count.
Clause 40. The system of clause 27, wherein the scan area comprises a scan area to classify a plurality of RBCs for an RBC count.
Clause 41. The system of clause 27 wherein the patient data corresponds to an abnormal cell type and the processor is configured to adjust the scan area in response to the abnormal cell type.
Clause 42. The system of clause 41, wherein the patient data corresponds to an anemia of the patient and the processor is configured to increase the scan area to detect one or more of tear drop cells (“dacrocytes”) one or more of schistocytes.
Clause 43. The system of clause 27, wherein the scan area comprises an area to detect parasites.
Clause 44. The system of clause 1, wherein the processor is configured to: receive a user input corresponding to a type of cell to analyze; and determine the scan area in response to the user input.
Clause 45. The system of clause 44, wherein the type of cell to analyze comprises one or more of a red blood cell count, a platelet count, a platelet morphology, a WBC count, a WBC differential count, a bone marrow megakaryocyte count, or a parasite detection.
Clause 46. The system of clause 1, wherein the processor is configured to: scan a plurality of samples in an automated mode and to enter a manual mode of operation to receive a user input.
Clause 47. The system of clause 1, wherein the scanning apparatus comprises an optical microscope configured with a substantially fixed illumination light source to capture a plurality of images of the sample and optionally wherein the scanning apparatus is configured to sequentially acquire the plurality of images from different areas of the sample.
Clause 48. The system of clause 1, wherein the scanning apparatus comprises computational microscope configured to vary a light source with a plurality of illumination angles to capture a plurality of images of the sample and optionally wherein the processor is configured to process the plurality of images to generate a high resolution image of the scan area.
Clause 49. The system of clause 1, wherein the processor is configured to output the cell data to a user interface, the cell data comprising one or more of cell statistics, cell counts, cell populations, cell types, parasites, or a digital scan image.
Clause 50. The system of clause 49, wherein the processor is configured to present the digital scan image with a size and resolution suitable for a user to select a cell in the image and present data for the cell in response to the user selecting the cell.
Clause 51. A method for scanning a hematology sample of a patient, the method comprising: scanning the hematology sample with a scanning apparatus; receiving, with a processor, a first image of the sample at a first resolution; determining, with the processor, a scan area of the sample to scan in response to the first image of the sample; generating, with the processor, an image of the scan area at a second resolution greater than the first resolution; classifying, with the processor, a plurality of cells from the image of the scan area into cell data comprising a plurality of cell parameters for the plurality of cells; and outputting the cell data.
Clause 52. The method of clause 51, wherein the scan area comprises at least 0.4 cm² and an optical resolution of the image of the scan area is within a range from about 200 nm to about 500 nm and optionally within a range from about 200 nm to about 400 nm.
Clause 53. The method of clause 52, wherein a pixel resolution of the image of the scan area is within a range from about 100 nm to about 250 nm and optionally within a range from about 100 nm to about 200 nm.
Clause 54. The method of clause 51, wherein the hematology sample comprises a body, a monolayer of cells and a feathered edge and wherein, the scan area is selected in response to one or more of a location of the body, a location of the monolayer of cells, or a location of the feathered edge.
Clause 55. The method of clause 51, wherein the first image comprises one or more of a preview image, a webcam image, or an image from the scanning apparatus.
Clause 56. The method of clause 55, wherein the first image comprises a plurality of first images captured over different fields of view, the plurality of first images comprising no more than two images, and optionally fewer than 5 images, optionally fewer than 10 images, optionally fewer than 20 images, or optionally fewer than 50 images.
Clause 57. The method of clause 55, wherein the scan area is determined in response to one or more of identified locations of cells in the first image, a density of cells in an area of the first image, or relative densities of cells at different areas of the first image.
Clause 58. The method of clause 51, wherein the scan area to scan is dynamically adjusted in response to cell data from the image of the scan area.
Clause 59. The method of clause 58, wherein a number of red blood cells are detected and counted over at least a portion of the scan area and to adjust the scan area in response to the number of detected red blood cells and optionally wherein the number comprises a number per unit area and optionally wherein the scan area is adjusted in response to a number of non-overlapping red blood cells.
Clause 60. The method of clause 58, wherein a number of white blood cells are detected and counted over at least a portion of the scan area and to adjust the scan area in response to the number of detected white blood cells and optionally wherein the number comprises a number per unit area.
Clause 61. The method of clause 58, wherein the plurality of cell parameters is classified during the scan of the scan area and the scan of the scan area is dynamically adjusted in response to the plurality of cell parameters and optionally wherein the plurality of cell parameters comprises a plurality of cell types.
Clause 62. The method of clause 61, wherein the plurality cell parameters are classified with an artificial intelligence (AI) algorithm during the scan of the scan area.
Clause 63. The method of clause 62, wherein the AI algorithm comprises on or more of a statistical classifier or a neural network classifier.
Clause 64. The method of clause 62, wherein at least 10 classifiers are processed in parallel with each other and with the scanning of the scan area.
Clause 65. The method of clause 58, wherein the scan area is dynamically adjusted in response to a gradient of cells in the area.
Clause 66. The method of clause 58, wherein the area is dynamically adjusted from a first area scanned with the scanning apparatus to a second area not yet scanned with the scanning apparatus in response to the cell data.
Clause 67. The method of clause 66, wherein the first area does not overlap with the second area and optionally wherein a gap extends between the first area and the second area and scanning of the sample with the scanning apparatus is skipped between the first area and the second area.
Clause 68. The method of clause 58, wherein the cell data comprises one or more of a cell type, a rare cell type, a density of cells of a cell type, a number of cells of a cell type, or a target number of cells of a cell type.
Clause 69. The method of clause 68, wherein the rare cell type comprises one or more of a blast cell, a plasma cell, a myelocyte or a promyelocyte, a circulating lymphoma cell, an immature cell, a hairy cell a binucleated cell (“buttocks cell”), a Sezary cell, or a cup-like blast.
Clause 70. The method of clause 69, wherein the scan area is increased in response to the rare cell type and optionally wherein the rare cell type comprises an abnormal cell type.
Clause 71. The method of clause 58, wherein the plurality of cell parameters comprises a parameter corresponding to a size of a cell and wherein the scan area is adjusted to scan a feathered edge of the sample in response to the size of the cell.
Clause 72. The method of clause 71, wherein the cell comprises a distance across greater than 20 um and optionally wherein the scan area is adjusted from a monolayer or a body of the sample to the feathered edge in response to the size of the cell.
Clause 73. The method of clause 58, wherein the scan area is adjusted to an edge of the sample in response to a platelet count below a threshold value.
Clause 74. The method of clause 58, wherein the scan area is increased in response to a WBC count below a threshold value and optionally the scan area is decreased in response to the WBC count above a threshold value.
Clause 75. The method of clause 58, wherein the plurality of cell parameters comprises one or more of a total WBC count or a count of a type of WBC and the scan area is adjusted in response to the one or more of the total WBC count or the count of the type of WBC.
Clause 76. The method of clause 75, wherein the scan area is increased in response to the one or more of the total WBC count or the count of the type of WBC below a threshold value.
Clause 77. The method of clause 51, wherein patient data is received prior to scanning the sample.
Clause 78. The method of clause 77, wherein the patient data comprises one or more of flow cytometry data from a flow cytometer or a complete blood count (“CBC”) from a CBC machine.
Clause 79. The method of clause 78, wherein the flow cytometry data comprises a platelet count.
Clause 80. The method of clause 77, wherein the patient data comprises one or more of a complete blood count (“CBC”), a white blood cell (“WBC”) count, a WBC differential count, a red blood cell (“RBC”) count, or a platelet count and optionally wherein the WBC differential count comprises relative amounts of neutrophils, eosinophils, basophils, lymphocytes and monocytes.
Clause 81. The method of clause 80, wherein the patient data comprises prior diagnostic data of the patient.
Clause 82. The method of clause 81, wherein the prior diagnostic data comprises the WBC differential count and the area is determined in response to cell counts of the WBC differential count.
Clause 83. The method of clause 82, wherein the WBC differential count comprises one or more cell types outside a normal range and an area of the sample having an increased likelihood of presence is determined for the one or more cell types outside the normal range.
Clause 84. The method of clause 77, wherein the scan area is defined to classify a plurality of platelets for a platelet count and platelet morphology.
Clause 85. The method of clause 84, wherein the scan area comprises a feathered edge of the sample.
Clause 86. The method of clause 85 wherein the scan area comprises the feathered edge of the sample in response to a low platelet count.
Clause 87. The method of clause 85, wherein clumped platelets are detected and optionally wherein the plurality of cell parameters comprises a clumped platelet parameter.
Clause 88. The method of clause 87, wherein an image of the clumped platelets is presented to a user to verify detection and classification of the clumped platelets.
Clause 89. The method of clause 77, wherein the scan area comprises a scan area to classify a plurality of WBCs for a WBC differential count.
Clause 90. The method of clause 77, wherein the scan area comprises a scan area to classify a plurality of RBCs for an RBC count.
Clause 91. The method of clause 77 wherein the patient data corresponds to an abnormal cell type and the scan area is adjusted in response to the abnormal cell type.
Clause 92. The method of clause 91, wherein the patient data corresponds to an anemia of the patient and the scan area is increased to detect one or more of tear drop cells (“dacrocytes”) one or more of schistocytes.
Clause 93. The method of clause 77, wherein the scan area comprises an area to detect parasites.
Clause 94. The method of clause 51, wherein: a user input is received, the user input corresponding to a type of cell to analyze; and the scan area is determined in response to the user input.
Clause 95. The method of clause 94, wherein the type of cell to analyze comprises one or more of a red blood cell count, a platelet count, a platelet morphology, a WBC count, a WBC differential count, a bone marrow megakaryocyte count, or a parasite detection.
Clause 96. The method of clause 51, wherein a plurality of samples is scanned in an automated mode and a manual mode of operation has been entered to receive a user input.
Clause 97. The method of clause 51, wherein the scanning apparatus comprises an optical microscope configured with a substantially fixed illumination light source to capture a plurality of images of the sample and optionally wherein the scanning apparatus sequentially acquires the plurality of images from different areas of the sample.
Clause 98. The method of clause 51, wherein the scanning apparatus comprises computational microscope configured to vary a light source with a plurality of illumination angles to capture a plurality of images of the sample and optionally wherein the plurality of images is processed to generate a high resolution image of the area.
Clause 99. The method of clause 51, wherein the cell data is output to a user interface, the cell data comprising one or more of cell statistics, cell counts, cell populations, cell types, parasites, or a digital scan image.
Clause 100. The method of clause 99, wherein the digital scan image is presented with a size and resolution suitable for a user to select a cell in the image and present data for the cell in response to the user selecting the cell.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A system for scanning a hematology sample of a patient, the system comprising:
a scanning apparatus to scan the hematology sample;
a processor coupled to the scanning apparatus and a memory and configured to execute instructions which cause the system to:
receive a first image of the sample at a first resolution;
determine a scan area of the sample to scan in response to the first image of the sample;
scan the scan area to generate an image of the scan area at a second resolution greater than the first resolution;
classify a plurality of cells from the image of the scan area into cell data comprising a plurality of cell parameters for the plurality of cells; and
output the cell data.

2. The system of claim 1, wherein the scan area comprises at least 0.4 cm2 and an optical resolution of the image of the scan area is within a range from about 200 nm to about 500 nm and optionally within a range from about 200 nm to about 400 nm.

3. The system of claim 2, wherein a pixel resolution of the image of the scan area is within a range from about 100 nm to about 250 nm and optionally within a range from about 100 nm to about 200 nm.

4. The system of claim 1, wherein the hematology sample comprises a body, a monolayer of cells and a feathered edge and wherein, the processor is configured to select the scan area in response to one or more of a location of the body, a location of the monolayer of cells, or a location of the feathered edge.

5. The system of claim 1, wherein the first image comprises one or more of a preview image, a webcam image, or an image from the scanning apparatus.

6. The system of claim 5, wherein the first image comprises a plurality of first images captured over different fields of view, the plurality of first images comprising no more than two images, and optionally fewer than 5 images, optionally fewer than 10 images, optionally fewer than 20 images, or optionally fewer than 50 images.

7. The system of claim 5, wherein the processor is configured to determine the scan area in response to one or more of identified locations of cells in the first image, a density of cells in an area of the first image, or relative densities of cells at different areas of the first image.

8. The system of claim 1, wherein the processor is configured to dynamically adjust the scan area to scan in response to cell data from the image of the scan area.

9. The system of claim 8, wherein the processor is configured to detect and count a number of red blood cells over at least a portion of the scan area and to adjust the scan area in response to the number of detected red blood cells and optionally wherein the number comprises a number per unit area and optionally wherein the scan area is adjusted in response to a number of non-overlapping red blood cells.

10. The system of claim 8, wherein the processor is configured to detect and count a number of white blood cells over at least a portion of the scan area and to adjust the scan area in response to the number of detected white blood cells and optionally wherein the number comprises a number per unit area.

11. The system of claim 8, wherein the processor is configured to classify the plurality of cell parameters during the scan of the scan area and to dynamically adjust the scan of the scan area in response to the plurality of cell parameters and optionally wherein the plurality of cell parameters comprises a plurality of cell types.

12. The system of claim 11, wherein the processor is configured to classify the plurality of cell parameters with an artificial intelligence (AI) algorithm during the scan of the scan area.

13. The system of claim 12, wherein the AI algorithm comprises on or more of a statistical classifier or a neural network classifier.

14. The system of claim 12, wherein the processor is configured to run at least 10 classifiers in parallel with each other and with the scanning of the scan area.

15. The system of claim 8, wherein the processor is configured to dynamically adjust the scan area in response to a gradient of cells in the scan area.

16. The system of claim 8, wherein the processor is configured to dynamically adjust the scan area from a first area scanned with the scanning apparatus to a second area not yet scanned with the scanning apparatus in response to the cell data.

17. The system of claim 16, wherein the first area does not overlap with the second area and optionally wherein a gap extends between the first area and the second area and the processor is configured to skip scanning of the sample with the scanning apparatus between the first area and the second area.

18. The system of claim 8, wherein the cell data comprises one or more of a cell type, a rare cell type, a density of cells of a cell type, a number of cells of a cell type, or a target number of cells of a cell type.

19. The system of claim 18, wherein the rare cell type comprises one or more of a blast cell, a plasma cell, a myelocyte or a promyelocyte, a circulating lymphoma cell, an immature cell, a hairy cell a binucleated cell (“buttocks cell”), a Sezary cell, or a cup-like blast.

20. The system of claim 19, wherein the processor is configured to increase the scan area in response to the rare cell type and optionally wherein the rare cell type comprises an abnormal cell type.

21.-100. (canceled)
